(19) United States
(12) Patent Application Publication
(10) Pub. No.: US 2022/0297613 A1
(43) Pub. Date: Sep. 22, 2022

(54) ROOF BICYCLE CARRIER

(71) Applicant: F.LLI MENABO' S.R.L., 42025 Cavriago (RE) (IT)

(72) Inventors: Andrea Salsi, Bagnolo In Piano (IT); Domenico Menabo', Reggio Emilia (IT)

(21) Appl. No.: 17/697,210

(22) Filed: Mar. 17, 2022

(30) Foreign Application Priority Data
Mar. 18, 2021 (IT) 102021000006536

(51) Int. Cl. B60R 9/10; B60R 9/048

(52) U.S. Cl. CPC B60R 9/10; B60R 9/048

(57) ABSTRACT

A bicycle carrier (1) comprising a support base (10) for the wheels of a bicycle (100) and anchoring means (2), connected to the support base (10) and arranged to engage the handlebar (103) of the bicycle (100).

The present invention relates to a improved roof bicycle carrier.

Bicycle carriers to be mounted on roof bars that can be fixed to the roof of the car are known.

These known bicycle carriers comprise a profile that is anchored transversely to the bars and is provided with an upper groove or “rail” that accommodates the tires of one or both wheels of the bicycle.

In more detail, these known bicycle carriers can be divided into two main types.

In a first type, the rear wheel of the bicycle is accommodated on the rail and fixed there by a plastic strap while the front wheel of the bicycle is removed and the now free end of the fork is fixed to a locking means with which the profile is provided.

These bicycle carriers are safe but require disassembly of the front wheel, which many users find uncomfortable.

In a second type of known bicycle carrier, both wheels of the bicycle are received by the profile rail. In this case, the bicycle is locked at the rear wheel by means of the strap already described above and is locked at the front by means of a U-shaped arm, hinged to the profile and arranged to be anchored to the bicycle frame, at one of the tubes of the front triangle.

This type of bicycle carrier is safe and comfortable and nevertheless its filed of application has recently been restricted by the fact that manufacturers have launched a variety of bicycle models on the market that are provided with frames of shapes and sizes that are completely different from one another.

In other words, although until recently the manufacturers of roof-mounted bicycle carriers were able to rely on a de facto standardization of the shape and size of the bicycle frame, today they have to chase the market, whose players want to distinguish themselves by proposing very different articles and which are also differentiated according to the customers for whom they are intended.

Therefore, it is now increasingly difficult to produce bicycle carriers of the type that is hooked to the frame; which can work effectively for all or many of the bicycle models on the market.

Finally, there are also bicycle carriers that lock both wheels to the profile. In this case, the profile is provided with means for locking the front wheel consisting of a U-shaped arm, similar to that already mentioned, which engages the top of the front tire. This type of bicycle carrier, however, has the disadvantage that, by deflating the front tire, it may be possible to remove and then steal the bicycle, when left temporarily unattended by the owner.

The technical task underlying the present invention is to propose a bicycle carrier which obviates the drawbacks of the prior art.

The stated technical task is achieved by the bicycle carrier made in accordance with claim 1.

Further features and advantages of the present invention will become more apparent from the following indicative, and hence non-limiting, description of a preferred, but not exclusive, embodiment of a bicycle carrier as illustrated in the appended drawings, in which:

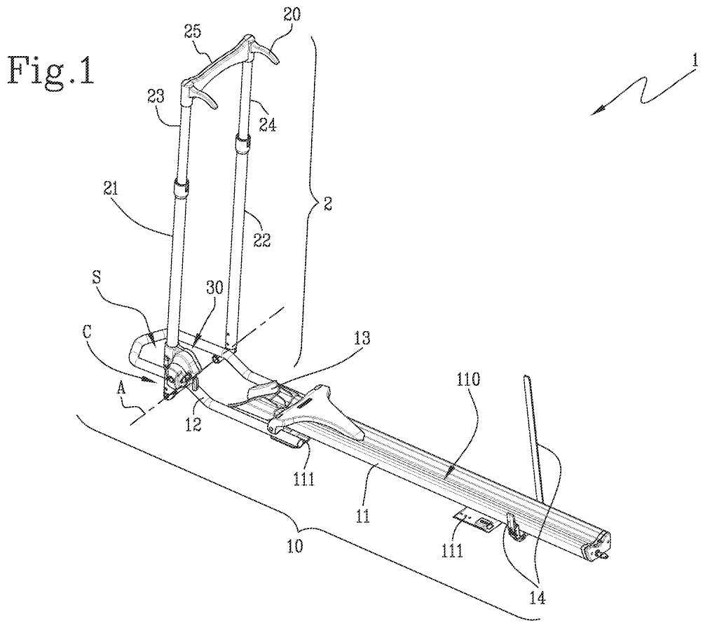

FIG. 1 represents an axonometric view of the bicycle carrier according to the invention;

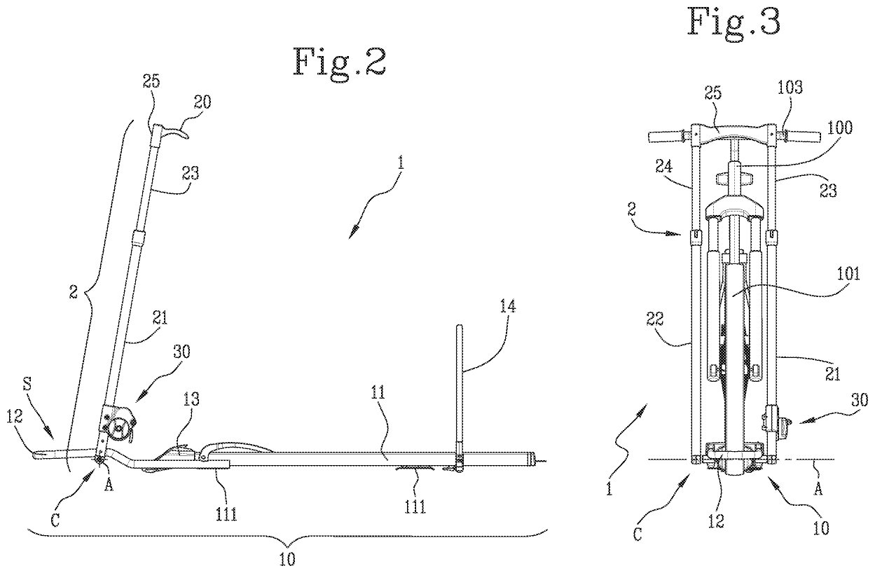

FIG. 2 represents a side view of the bicycle carrier of FIG. 1;

FIG. 3 represents a front view of the bicycle carrier of FIG. 1, in a configuration of use where it is carrying a bicycle;

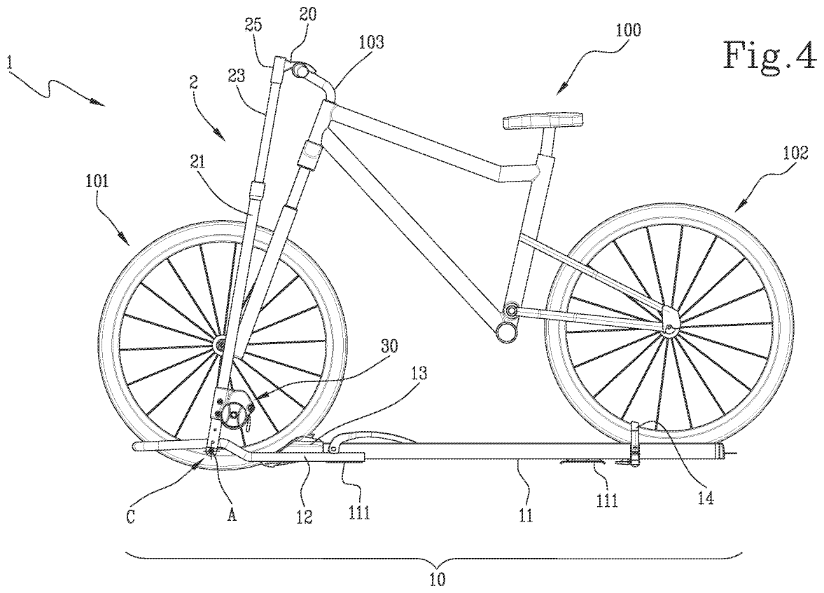

FIG. 4 represents a side view of the bicycle carrier of FIG. 3;

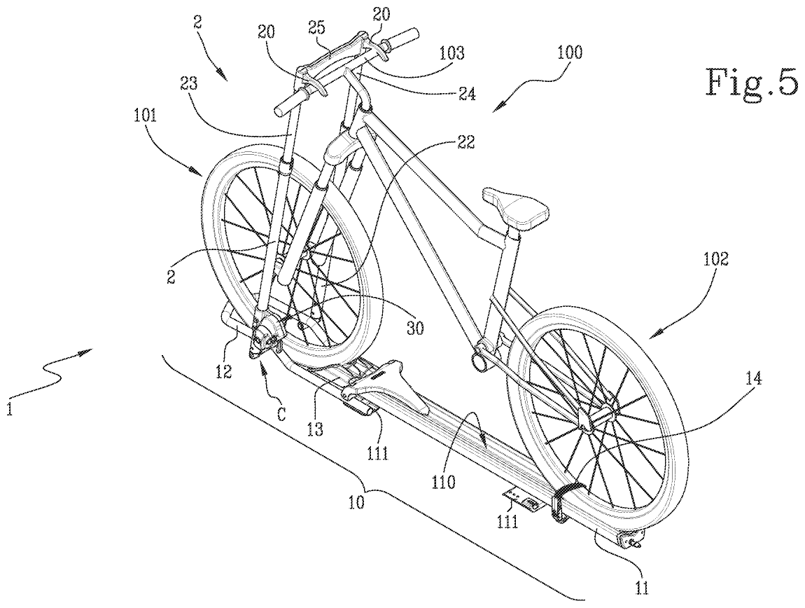

FIG. 5 represents an axonometric view of the bicycle carrier of FIG. 3;

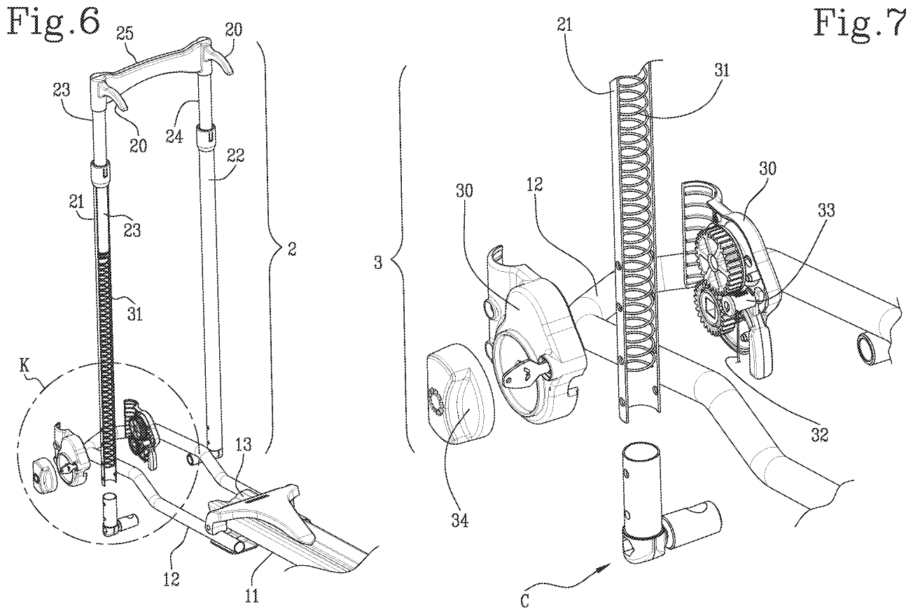

FIG. 6 is a partially cross-sectional and exploded view of the anchoring device of the invention; and

FIG. 7 shows the enlarged detail K of FIG. 6.

With reference to the above-mentioned figures, 1 generically denotes a bicycle carrier; according to the invention.

The bicycle carrier 1 is preferably of the type that is mounted on the roof bars fixed to the roof of the car and comprises a support base 10 for the wheels 101, 102 of the bicycle 100 and anchoring means 2 connected to the base 10 and arranged to engage the handlebar 103 of the bicycle.

In practice, the bicycle carrier 1 of the invention is designed to securely lock the front of the bicycle 100 by means of the anchoring means 2 that engages the handlebar 103 of the bicycle, instead of the frame or the front wheel 101 or the forks of the latter. This expedient makes the invention completely different from the known solutions on the market and, as will be explained in detail below, makes it able to overcome the drawbacks listed in the introduction.

The support base 10 of the invention has been designed to be kept, in use, horizontally and can comprise a straight support element 11, for example consisting of a metal profile; provided with a groove 110, or “rail”; to receive the rear wheel of the bicycle 100.

In the present description; the terms “upper” and “lower” will be used referring to the orientation that the bicycle carrier 1 assumes in the space during use and “front” will be used to refer to the front direction with respect to the bicycle 100 carried and “rear” to refer to the opposite direction.

The base 10 extends at the front from the profile 11 with a U-shaped or open-loop tubular element 12, lying substantially on the horizontal plane of the profile 11, which; together with a shaped block 13 fixed to the front end of the profile 11, defines a receiving seat S for the front wheel 101 of the bicycle 100.

In other words, the front tubular element 12 and the shaped block 13, which forms a hollow to accommodate the tire of the wheel 101 circumscribe the housing space of the front wheel 101 of the bicycle 100, thereby defining a perimeter frame 12, 13.

Once inserted into the front seat S, the wheel 101 protrudes partly from under the perimeter frame 12, 13 of the seat S and its horizontal movements are locked by the constraints constituted by the inner surface of the curved fold of the tubular element 12 and by the hollow of the block 13 opposite thereto.

Constructively, the rear ends of the tubular element 12 may be joined to a front portion of the profile 11.

The profile 11 is provided, at a rear portion thereof, with a strap 14 for locking the rear wheel 102, which is designed to embrace the rim and the tire.

The aforementioned anchoring means preferably include an anchoring device 2 provided with engagement elements 20 the handlebar 103.

In the preferred, but not binding, embodiment shown in the figures, the anchoring device 2 is hinged to the base 10, around a horizontal axis A transversal thereto, at the seat S for the front wheel 101, for example by means of pins fixed to the aforementioned tubular element 12, so as to extend upwards and be able to oscillate back and forth like a flag.

In the preferred version thereof, the anchoring device 2 has a form of an inverted U and includes two lower straight tubular elements 21, 22, which are connected to the base 10 and define a lower part of the device 2 and two upper straight tubular elements 23, 24, which are inserted with the possibility of sliding in the lower tubular elements 21, 22, which are joined by an upper crossbar 25, bearing the aforementioned engaging elements 20, to define an upper part of the device.

In the example illustrated in the accompanying figures, the engaging elements are two forks 20, or hooks, with lower concavity, which protrude in a cantilevered manner from the upper crossbar of the anchoring device 2 and have the function of abutting from above the handlebar 103.

More generally, the anchoring device 2 of the invention comprises an upper part 23, 24, 25, provided with the engaging elements 20 which is movable with respect to a lower part 21, 22, which is connected to the base 10. More in detail, the upper part 23, 24, 25 of the device can be longitudinally slidable with respect to the lower part 21, 22, to allow adjusting the distance between the engaging elements 20 and the end of the lower part 21, 22 connected to the base 10, i.e. the one hinged to the front seat S, in the embodiment example shown in the figures.

Thus, the anchoring device 2 is telescopically extendable, so as to be able to adjust its length and is also oscillable about a horizontal axis A, so as to be able to adjust the position of the engaging elements 20 in accordance with the height and position of the handlebar 103.

Preferably, the anchoring device 2 comprises adjustment means 3 (shown in FIGS. 6 and 7) suitable for adjusting the reciprocal position of the lower and upper parts 21, 22, 23, 24, 25 thereof, or the length of the device 2 itself, which is also equivalent to adjusting the distance between the engaging elements 20 and the hinge C. Although in the embodiment represented in the accompanying drawings the adjustment means 3 is designed to be manually operated by a user, versions in which they are automatically operated, for example by means of servomechanisms, are not excluded.

In the preferred embodiment, the adjustment means 3 includes two springs 31, inserted in respective lower tubular elements 21, 22 of the device 2 and adapted to exert a thrust on the upper tubular elements 23, 24, so as to normally keep the engaging elements 20 in the position of maximum distance from the hinge C.

Furthermore, within one of the lower tubular elements 21, 22, for example the left one, a cable 32 runs which is fixed at one end to the upper tubular element 23 or to the crossbar 25 and is wound below around a spool 33, for example fixed to the relative tubular element 21, on which the user can act by means of a knob 34.

In this way, the user can adjust the length of the device 2, i.e. the distance between the engaging elements 20 and the hinge C, simply by turning the knob 34, so as to recover the cable 32 and progressively overcome the force of the springs 31.

More generally, the adjustment means 3 of the invention comprises one or more elastic elements acting between the lower and upper parts of the anchoring device 2. These elastic elements can be adapted to bring the upper part 23, 24, 25 into its position of maximum distance with respect to the lower end of the lower part 21, 22. Furthermore, the adjustment means 3 may comprise a cable 32 connected to the upper part 23, 24, 25 of the device and a spool 33 on which the cable 32 is wound.

The operation of the invention is explained below, with reference to the accompanying figures.

It preferably starts with the anchoring device 2 raised and in the maximum length rest position, i.e. with the cable 32 loose or in any case at minimum tension.

The bicycle is placed on the base 10, with the front wheel 101 housed in the front seat S mentioned several times and the rear wheel 102 placed in the rail 110 of the profile 11.

The anchoring device 2 is rotated backwards until it contacts the handlebar 103. Thereafter, the knob 34 of the spool 33 is turned so as to bring the engaging elements 20 into contact with the upper surface of the handlebar 103 and, by means of a downward thrust, to securely lock the front part of the bicycle 100 to the bicycle carrier 1 itself, which is then gripped between the front seat S and the engaging elements 20.

The spool 33 is preferably contained in a box 30, provided with a door to access the knob 34, which is provided with a safety lock.

At this point, the rear strap 14 is fastened around the rim and the tire of the rear wheel 102, so as to also lock the rear part of the bicycle 100.

Once the bicycle 100 is made solidly constrained to the base 10 of the bicycle carrier 1, this is mounted on the bars by means of special fixing plates 111 with which the base 10 is provided below.

Since the bicycle carrier 1 proposed anchors the front part of the bicycle 100 by involving the handlebar 103 and is able to adjust the angular position and length of the anchoring device 2, adapting it to the height and relative position of the handlebar 103 of the specific bicycle carried, then it is clear that it overcomes all the drawbacks of the prior art.

Indeed, the invention can securely anchor any bicycle 100, regardless of the shape and size of the frame thereof, but also those of the handlebar 103.

Furthermore, even by deflating the front tire, it is not possible to release the front part of the bicycle 100 from the bicycle carrier 1, since the front wheel 101 is embedded in the front seat S, where it is circumscribed by the perimeter frame 12, 13 at an intermediate height and the anchoring device 2 presses the handlebar 103 from above constituting a superior constraint to the movement of the bicycle 100. In other words, even when deflating the tire, there is not enough play to allow the bicycle 100 to be removed.

Finally, in addition to the improved versatility and safety, the invention maintains the convenience of not having to disassemble the front wheel 101.

1. A bicycle carrier (1) comprising—a support base (10) for bicycle wheels (100) and anchoring means (2), connected to said base (10) and arranged to engage a handlebar (103) of the bicycle (100).

2. The bicycle carrier (1) according to claim 1, wherein the base (10) includes a straight support element (11) provided with at least one groove (110) to receive one or more of said wheels.

3. The bicycle carrier (1) according to claim 1, wherein said anchoring means (2) comprise an anchoring device (2) provided with one or more engaging elements (20) suitable for engaging said handlebar (103).

4. The bicycle carrier (1) according to claim 3, wherein said anchoring device (2) is hinged to the base (10).

5. The bicycle carrier (1) according to claim 3, wherein the anchoring device (2) comprises an upper part (23, 24, 25), provided with said engaging elements (20), which is movable with respect to a lower part (21, 22) of the device (2), which is connected to the base (10).

6. The bicycle carrier (1) according to claim 5, wherein the upper part (23, 24, 25) of the device (2) is slidable with respect to the lower part (21, 22), to enable adjusting a distance between the engaging elements (20) and an end of the lower part (21, 22) connected to the base (10).

7. The bicycle carrier (1) according to claim 4, wherein the anchoring device (2) comprises an upper part (23, 24, 25), provided with said engaging elements (20), which is movable with respect to a lower part (21, 22) of the device (2), which is connected to the base (10), and wherein a lower end of the lower part (21, 22) is hinged to the base (10), about an axis of rotation (A) transversal to the base (10).

8. The bicycle carrier (1) according to claim 6, wherein the anchoring device (2) comprises adjustment means (3) suitable for adjusting the reciprocal position between the lower part and upper part thereof.

9. The bicycle carrier (1) according to claim 8, wherein said adjustment means (3) are manually activatable by a user.

10. The bicycle carrier (1) according to claim 8, wherein the adjustment means (3) comprise one or more elastic elements (31) acting between the lower part and upper part (21, 22, 23, 24, 25) thereof.

11. The bicycle carrier (1) according to claim 10, wherein said elastic elements (31) are adapted to bring the upper part (23, 24, 25) into a position of maximum distance with respect to said lower end of the lower part (21, 22).

12. The bicycle carrier (1) according to claim 11, wherein the adjustment means (3) comprise a cable (32) connected to the upper part (23, 24, 25) of the device and a spool (33) on which the cable (32) is wound.

13. The bicycle carrier (1) according to claim 5, wherein the anchoring device (2) comprises a frame in the form of an inverted U, which includes two lower tubular elements (21, 22) which are connected to the base (10) and constitute the said lower part (21, 22) and two upper tubular elements (23, 24), sliding linked to respective lower tubular elements (21, 22), which are joined by an upper crossbar, bearing said anchoring elements, to define the aforesaid upper part (23, 24, 25) of the device.

14. The bicycle carrier (1) according to claim 1, wherein the base (10) comprises a seat for receiving (S) a front wheel (101) of the bicycle (100), at which said anchoring means (2) are connected.

15. The bicycle carrier (1) according to claim 2, wherein the base (10) comprises a seat for receiving (S) a front wheel (101) of the bicycle (100), at which said anchoring means (2) are connected, and wherein said seat (S) is perimetrically defined by a U-shaped tubular tire (13), rear ends of which are joined to a front portion of said straight element (11), which supports the rear wheel (102) of the bicycle (100).
